(19) United States
(12) Patent Application Publication
(10) Pub. No.: US 2025/0020131 A1
(43) Pub. Date: Jan. 16, 2025

(54) AXIAL FAN, AIR-SENDING DEVICE, AND REFRIGERATION CYCLE APPARATUS

(71) Applicant: Mitsubishi Electric Corporation, Tokyo (JP)

(72) Inventors: Katsuyuki YAMAMOTO, Tokyo (JP); Takuya TERAMOTO, Tokyo (JP); Kazuya OKADA, Tokyo (JP); Koji YAMAGUCHI, Tokyo (JP)

(21) Appl. No.: 18/713,478

(22) PCT Filed: Dec. 13, 2021
(86) PCT No.: PCT/JP2021/045745

§ 371 Date: May 24, 2024

(51) Int. Cl. F04D 19/00; F04D 29/38; F04D 29/52; F25D 17/06

(52) U.S. Cl. CPC F04D 19/002; F04D 29/38; F04D 29/522; F25D 17/067

(57) ABSTRACT

An axial fan includes a plurality of blades, and a connection part. The plurality of blades are configured to rotate around a central axis defined by a fan shaft. The connection part is plate-like shaped, formed around the fan shaft, and connects, among the plurality of blades, blades that are adjacent to each other in a circumferential direction. The connection part includes a discontinuous part. The discontinuous part forms a stress distribution part that distributes stress imposed on the connection part when the plurality of blades rotate.

### TECHNICAL FIELD

The present disclosure relates to an axial fan including blades, an air-sending device including the axial fan, and a refrigeration cycle apparatus including the axial fan.

### BACKGROUND ART

An axial fan in the related art includes a plurality of blades, and a boss part to which the blades are connected. Such an axial fan is configured to generate a flow of air through rotation of the blades (see, for example, Patent Literature 1).

In an axial fan described in Patent Literature 1, to reduce backflow of air at the inboard part of the axial fan and to reduce air-sending noise produced as the axial fan sends air, each blade includes an auxiliary vane provided to the edge located rearward in the rotational direction of the blade (to be referred to as “trailing edge part” hereinafter). The auxiliary vane extends rearward in the rotational direction from the trailing edge part of the blade.

### CITATION LIST

### Patent Literature

Patent Literature 1: Japanese Unexamined Patent Application Publication No. 2019-173621

### SUMMARY OF INVENTION

### Technical Problem

The axial fan described in Patent Literature 1 includes a cylindrical boss part disposed in the central portion. In this regard, however, recent years have seen development of axial fans of the boss-less type with no boss part provided (to be referred to as “boss-less fan” hereinafter).

In boss-less fans, the trailing edge part of the leading blade, which is one of two mutually adjacent blades that is located forward in the rotational direction, and the leading edge part of the trailing blade, which is the other one of the two mutually adjacent blades that is located rearward in the rotational direction, are connected to each other via a continuous surface (to be referred to as “connection part” hereinafter) with no boss part in between.

With an axial fan with a boss part such as one described in Patent Literature 1, the presence of the boss part adds to the weight of the axial fan. This makes it difficult to achieve weight reduction, and consequently energy saving. Further, the boss part has no capability to send air, which makes it difficult to improve the air-sending efficiency of the axial fan. The air-sending efficiency of an axial fan is generally known to increase with increasing inboard-directed flow of air. However, the presence of the boss part in the central portion means that there is a limit to how much the inboard-directed flow of air can be increased.

By contrast, a boss-less fan includes no boss part in the central portion. This helps to mitigate the problems mentioned above. The absence of a boss part in such a boss-less fan, however, leads to reduced strength in the central portion. This results in insufficient strength in the central portion, which leads to increased blade deformation due to the centrifugal force generated when the boss-less fan rotates. The resulting inability to maintain the blade's shape leads to reduced air-sending capability. Further, strong wind conditions such as typhoons may cause the blades to rotate at high speed, and the resulting centrifugal force may cause the blades or the connection part for the blades to break. Examples of conceivable methods for ensuring the strength in the central portion of the boss-less fan include a method of increasing the material thickness of the blades and the material thickness of the connection part in the vicinity of the rotary shaft, and a method of providing the central portion with a reinforcing rib. Both of these methods, however, result in increased weight in the central portion of the boss-less fan. This may compromise a weight reduction effect, which is an advantage provided by the boss-less construction.

The present disclosure is directed to addressing the issues mentioned above. It is accordingly an object of the present disclosure to provide an axial fan, an air-sending device, and a refrigeration cycle apparatus that make it possible to ensure compatibility between an advantage provided by the boss-less construction (i.e., reduced weight and improved air-sending efficiency of the axial fan), and maintaining of blade strength.

### Solution to Problem

An axial fan according to an embodiment of the present disclosure includes a plurality of blades, and a connection part. The plurality of blades are configured to rotate around a central axis defined by a fan shaft. The connection part is plate-like shaped, formed around the fan shaft, and connects, among the plurality of blades, blades that are adjacent to each other in a circumferential direction. The connection part includes a discontinuous part. The discontinuous part forms a stress distribution part that distributes stress imposed on the connection part when the plurality of blades rotate.

An air-sending device according to an embodiment of the present disclosure includes the axial fan mentioned above, a drive source, and a casing. The drive source is configured to provide a drive force to the axial fan. The casing houses the axial fan and the drive source.

A refrigeration cycle apparatus according to an embodiment of the present disclosure includes the air-sending device mentioned above, and a refrigerant circuit. The refrigerant circuit includes a condenser, and an evaporator. The air-sending device is configured to send air to at least one of the condenser and the evaporator.

### Advantageous Effects of Invention

In the axial fan, the air-sending device, and the refrigeration cycle apparatus according to an embodiment of the present disclosure, a connection part of the axial fan that connects circumferentially adjacent blades to each other includes a stress distribution part. The stress distribution part is defined by a discontinuous part of the connection part. The presence of the discontinuous part in the connection part leads to a corresponding decrease in the weight of the connection part. As described above, in the axial fan according to an embodiment of the present disclosure, the stress distribution part is defined by the discontinuous part. The connection part can be thus reduced in weight. This results in the ability to maintain blade strength while maintaining an advantage provided by the boss-less construction (i.e., reduced weight and improved air-sending efficiency of the axial fan).

### BRIEF DESCRIPTION OF DRAWINGS

FIG. 1 is a front view of an axial fan 10 according to Embodiment 1.

FIG. 2 is a perspective view of the axial fan 10 according to Embodiment 1.

FIG. 3 is a side view of the axial fan 10 according to Embodiment 1.

FIG. 4 is a front view of an axial fan 10R according to Comparative Example.

FIG. 5 is a partial enlarged view of FIG. 4.

FIG. 6 is an explanatory drawing illustrating variation of an inter-edge separation Lint, which will be described later, in the radial direction in the axial fan 10R according to Comparative Example.

FIG. 7 illustrates stress concentration in the axial fan 10R according to Comparative Example.

FIG. 8 is a front view of a stress distribution part 8 provided to the axial fan 10 according to Embodiment 1.

FIG. 9 is an explanatory drawing illustrating variation of the inter-edge separation Lint in the radial direction in the stress distribution part 8 of the axial fan 10 according to Embodiment 1.

FIG. 10 is a partial front view of a modification of the axial fan 10 according to Embodiment 1.

FIG. 11 illustrates a stress distribution effect in the axial fan 10 according to Embodiment 1.

FIG. 12 is a partial enlarged side view of the axial fan 10 according to Embodiment 1, illustrating the flow of air at a connection part 7 of the axial fan 10.

FIG. 13 is a partial enlarged side view of the axial fan 10 according to Embodiment 1, illustrating the flow of air at the connection part 7 of the axial fan 10.

FIG. 14 is an explanatory drawing illustrating the shape of blades 1 of the axial fan 10 according to Embodiment 1.

FIG. 15 is an explanatory drawing illustrating the shape of the blades 1 of the axial fan 10 according to Embodiment 1.

FIG. 16 is a partial front view of the axial fan 10 according to Embodiment 2.

FIG. 17 is a reference drawing illustrating an example of how stress is distributed in the stress distribution part 8 of the axial fan 10 according to Embodiment 1.

FIG. 18 is an explanatory drawing illustrating an example of how stress is distributed in the stress distribution part 8 of the axial fan 10 according to Embodiment 2.

FIG. 19 is a partial front view of the axial fan 10 according to Embodiment 3.

FIG. 20 is a partial front view of a modification of the axial fan 10 according to Embodiment 3.

FIG. 21 is a schematic diagram of an air-conditioning apparatus representing a refrigeration cycle apparatus according to Embodiment 4.

FIG. 22 is a perspective view, as viewed from near an air outlet, of an outdoor unit representing an example of an air-sending device according to Embodiment 4.

FIG. 23 is an explanatory top view of the outdoor unit illustrated in FIG. 22.

FIG. 24 is a perspective view of an outdoor unit representing an example of an air-sending device according to Embodiment 5.

FIG. 25 is an explanatory partial cross-sectional view of the outdoor unit illustrated in FIG. 24.

### DESCRIPTION OF EMBODIMENTS

An axial fan, an air-sending device, and a refrigeration cycle apparatus according to embodiments of the present disclosure are described below with reference to the drawings. The present disclosure is not limited to the embodiments disclosed herein. Various modifications can be made to the present disclosure without departing from the scope and spirit of the present disclosure. The present disclosure encompasses all possible combinations of features described with reference to the embodiments and their modifications below. Features designated by the same reference signs in the drawings represent the same or corresponding features throughout the specification. In the drawings, relative dimensions, shapes, or other features of components may differ from the actuality.

### Embodiment 1

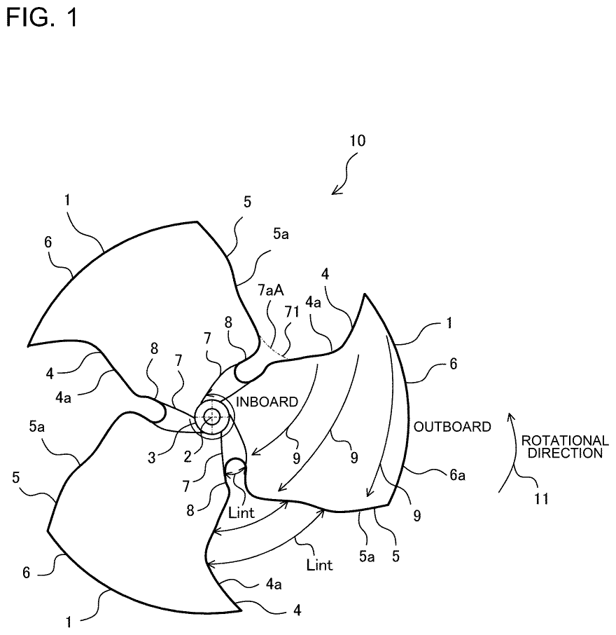

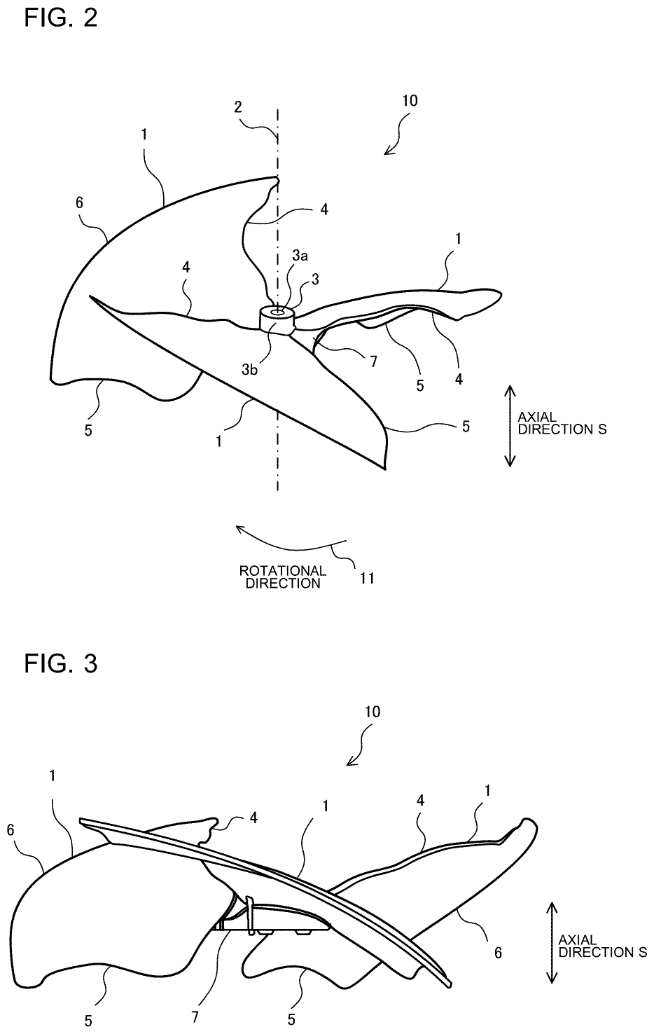

FIG. 1 is a front view of an axial fan 10 according to Embodiment 1. FIG. 2 is a perspective view of the axial fan 10 according to Embodiment 1. FIG. 3 is a side view of the axial fan 10 according to Embodiment 1. It is to be noted that for the simplicity of illustration, FIGS. 2 and 3 do not depict a stress distribution part 8. The axial fan 10 according to Embodiment 1 is an axial fan of a boss-less type including no boss part.

As illustrated in FIGS. 1 to 3, the axial fan 10 includes a plurality of blades 1, and is configured to rotate around the central axis defined by a fan shaft 2. Although three blades 1 are depicted in the example in FIG. 1, the number of blades 1 is not limited to three. The fan shaft 2 defines the central axis of the axial fan 10, and extends in an axial direction S illustrated in FIG. 2. A cylindrical shaft support 3 is disposed around the fan shaft 2 and supports a drive shaft 62 (see FIG. 23) of a fan motor 61 (see FIG. 23). As illustrated in FIG. 2, the shaft support 3 includes a through-hole 3a in the central portion. The through-hole 3a is engaged with the drive shaft 62 (see FIG. 23) of the fan motor 61 (see FIG. 23). The central axis of the drive shaft 62 coincides with the fan shaft 2.

As illustrated in FIGS. 1 to 3, each blade 1 has a leading edge part 4, a trailing edge part 5, and an outboard edge part 6. The leading edge part 4 defines an end portion located at the leading part of the blade 1 in a rotational direction 11 of the blade 1. The trailing edge part 5 defines an end portion located at the trailing part of the blade 1 in the rotational direction 11 of the blade 1. The outboard edge part 6 defines an outboard part of the blade 1. An edge 6a of the outboard edge part 6 is joined to an edge 4a of the leading edge part 4 and to an edge 5a of the trailing edge part 5. Hereinafter, as illustrated in FIG. 1, in the radial direction of the axial fan 10, locations near the fan shaft 2 are referred to as being “inboard”, and locations near the outboard edge part 6 are referred to as being “outboard.” An outboard direction thus refers to a direction away from the fan shaft 2 in the radial direction of the axial fan 10.

In the axial fan 10, circumferentially adjacent blades 1 are connected to each other by use of a plate-like connection part 7 in between. The connection part 7 is disposed between two mutually adjacent blades 1. Although three connection parts 7 are depicted in the example illustrated in FIG. 1, the number of connection parts 7 is not limited to three. Desirably, however, the number of connection parts 7 and the number of blades 1 are equal to each other. As illustrated in FIGS. 2 and 3, the connection part 7 is a continuous surface part formed by the following two edge parts that are made to stand in opposite directions in the axial direction S: the trailing edge part 5 of the leading blade 1, which is one of the two mutually adjacent blades 1 that is located forward in the rotational direction 11; and the leading edge part 4 of the trailing blade 1, which is the other one of the two mutually adjacent blades 1 that is located rearward in the rotational direction 11. According to Embodiment 1, the connection part 7 includes a discontinuous part. The discontinuous part extends through the connection part 7 in the direction of the material thickness of the connection part 7. The discontinuous part forms a stress distribution part 8, which distributes stress imposed on the connection part 7. In the example illustrated in FIG. 1, the stress distribution part 8 is a recess that radially extends toward the fan shaft 2 from the outboard end portion of the connection part 7. That is, the stress distribution part 8 is a cut in the form of a recess defined in the outboard end portion of the connection part 7. The outboard end portion of the connection part 7 is represented by an imaginary line 7aA in FIG. 1.

### Comparative Example

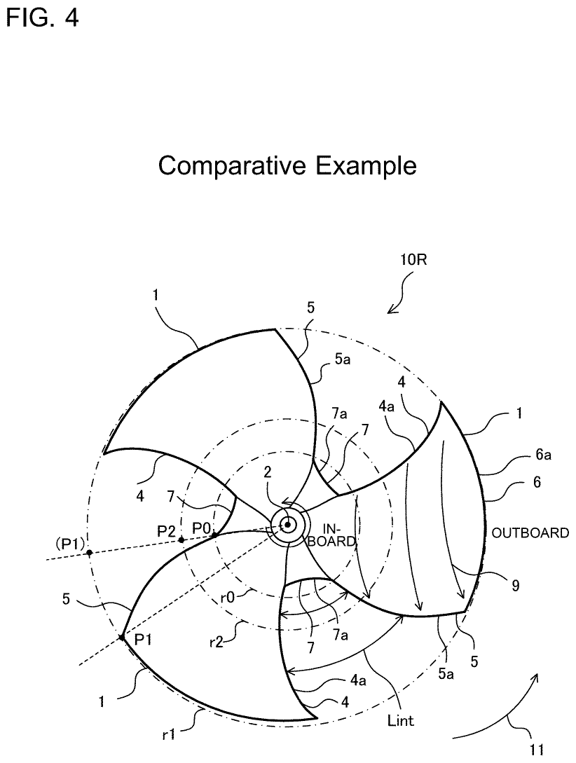

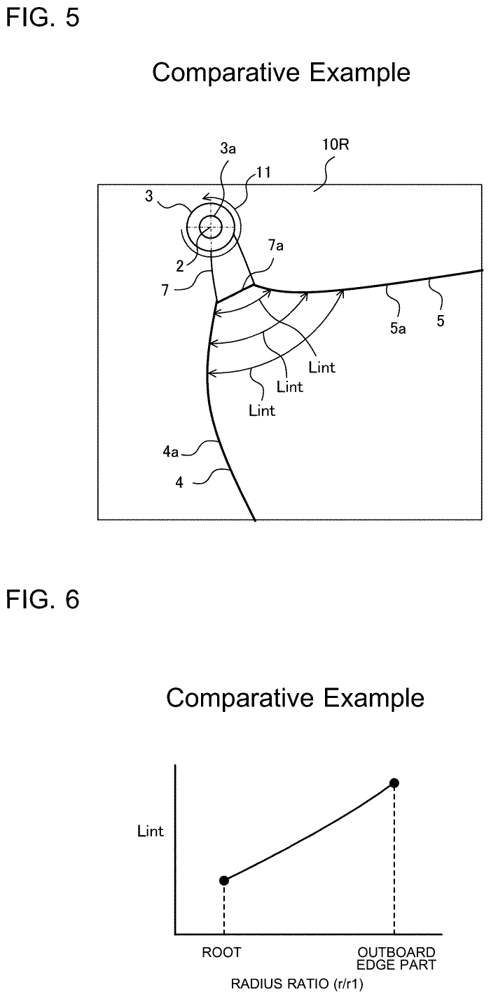

To facilitate explanation of the stress distribution part 8 of the axial fan 10 according to Embodiment 1, a configuration according to Comparative Example is first described below. FIG. 4 is a front view of an axial fan 10R according to Comparative Example. FIG. 5 is a partial enlarged view of FIG. 4. FIG. 6 is an explanatory drawing illustrating variation of an inter-edge separation Lint described later in the radial direction in the axial fan 10R according to Comparative Example.

As illustrated in FIG. 4, the axial fan 10R according to Comparative Example basically has features similar to those of the axial fan 10 according to Embodiment 1. Among the features of the axial fan 10R, features identical or corresponding to those of the axial fan 10 are designated by the same reference signs as those used for the axial fan 10, and not described here in further detail.

The axial fan 10R according to Comparative Example differs from the axial fan 10 according to Embodiment 1 in that the axial fan 10R according to Comparative Example does not include the stress distribution part 8. Other features are the same as those according to Embodiment 1, and thus designated by the same reference signs used for Embodiment 1. According to Comparative Example, the stress distribution part 8 according to Embodiment 1 is not provided. The absence of the stress distribution part 8 facilitates understanding of the features of the connection part 7 itself. Accordingly, the features of the connection part 7 are described below in particular detail with reference to Comparative Example.

As illustrated in FIG. 4, as with Embodiment 1, adjacent blades 1 of the axial fan 10R according to Comparative Example are likewise connected to each other by use of the plate-like connection part 7 in between. The edge 5a of the trailing edge part 5 of the leading blade 1, which is one of two mutually adjacent blades 1 that is located forward in the rotational direction, and the edge 4a of the leading edge part 4 of the trailing blade 1, which is the other one of the two mutually adjacent blades 1 that is located rearward in the rotational direction, are thus each joined to an edge 7a of the corresponding connection part 7.

As illustrated in FIG. 4, the connection parts 7 are located in the inboard part of the axial fan 10R. The connection parts 7 are arranged side by side around the fan shaft 2 at equal intervals in the circumferential direction. Each connection part 7 is disposed between two blades 1 that are circumferentially adjacent to each other. The connection part 7 is joined at opposite circumferential end portions to the two blades 1. The connection part 7 has a length in the radial direction less than the length of the blade 1 in the radial direction. As illustrated in FIG. 4, the edge 7a defining the outboard end portion of the connection part 7 is thus located radially further inboard than the edge 6a of the outboard edge part 6 of the axial fan 10R. The connection part 7 is connected at the inboard end portion to the side wall of the shaft support 3. In front view with the axial fan 10R projected onto a plane perpendicular to the fan shaft 2 of the axial fan 10R (to be referred to simply as “front view” hereinafter), the connection part 7 is trapezoidal or triangular in shape as illustrated in FIG. 4. In front view, a point where a radially extending straight line connecting the fan shaft 2 and the outboard edge part 6 intersects the outboard edge part 6 is defined as point P1. The point P1 represents the most outboard point on the edge 6a of the outboard edge part 6. The distance between the fan shaft 2 and the point P1 is referred to as radius r1 of the outboard edge part 6. That is, the radius r1 is the radius of a circle that passes through the point P1 on the outboard edge part 6 of the blade 1 most remote from the fan shaft 2, and that is centered on the fan shaft 2.

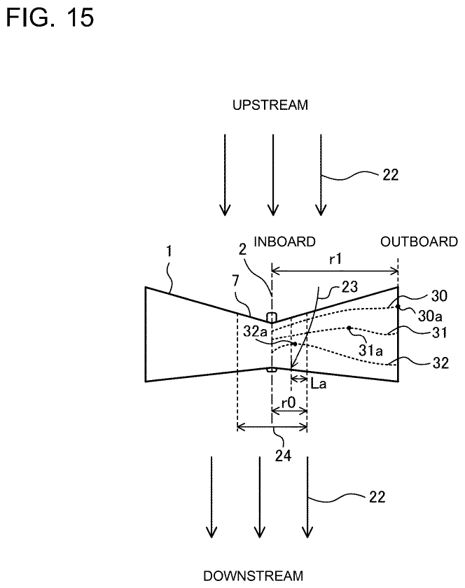

The point of intersection between the edge 7a of the connection part 7, and the edge 5a of the trailing edge part 5 of the blade 1 is defined as point PC, which represents the root position of the blade 1. As illustrated in FIG. 4, concentric circles centered on the fan shaft 2 in front view are considered below. A circle passing through the point PC and centered on the fan shaft 2 has a radius referred to as radius r0. That is, the radius r0 is the radius of a circle passing through the point PC, which represents the root position of the blade 1. The point P0 is defined as the most outboard point on the edge 7a of the connection part 7. The region inside the circle of the radius r0 thus represents an area where the connection part 7 is located (see arrows 24 in FIG. 15). The midpoint between the point P1 and the fan shaft 2 in the radial direction is defined as point P2, and the radius of a circle passing through the point P2 is referred to as radius r2. The length of the radius r2 is thus one-half the length of the radius r1 In this regard, the connection part 7 is disposed further inboard than the circumference of the radius r2. The radius r0 is thus less than one-half the radius r1 (r0<½×r1).

As represented by a plurality of arrows in FIG. 5, the distance between the respective edges of two mutually adjacent blades 1 is referred to as “inter-edge separation Lint on the circumference of the same radius” or simply “inter-edge separation Lint.” The inter-edge separation Lint is the distance between the following edges: the edge 5a of the trailing edge part 5 of the leading blade 1, which is one of the two mutually adjacent blades 1 that is located forward in the rotational direction 11; and the edge 4a of the leading edge part 4 of the trailing blade 1, which is the other one of the two mutually adjacent blades 1 that is located rearward in the rotational direction 11. More specifically, the inter-edge separation Lint is the separation between two mutually farthest edges on the circumference of a circle of the same radius centered on the fan shaft 2. That is, in front view, the inter-edge separation Lint is the length of an arc, on the circumference of a circle of the same radius centered on the fan shaft 2, between the edge 5a of the leading blade 1 and the edge 4a of the trailing blade 1.

With the inter-edge separation Lint defined as mentioned above, in the axial fan 10R according to Comparative Example, the inter-edge separation Lint increases gradually in a direction from the radially inboard part toward the radially outboard part as illustrated in FIG. 5. The graph in FIG. 6 represents variation of the inter-edge separation Lint in the radial direction. In FIG. 6, the vertical axis represents the inter-edge separation Lint, and the horizontal axis represents a radius ratio, which is defined as the ratio, to the radius r1, of the radius r of a circle concentric with the circle of the radius r1. It can be appreciated from FIG. 6 that the inter-edge separation Lint increases gradually in a radially outboard direction from the point PC, which represents the root position.

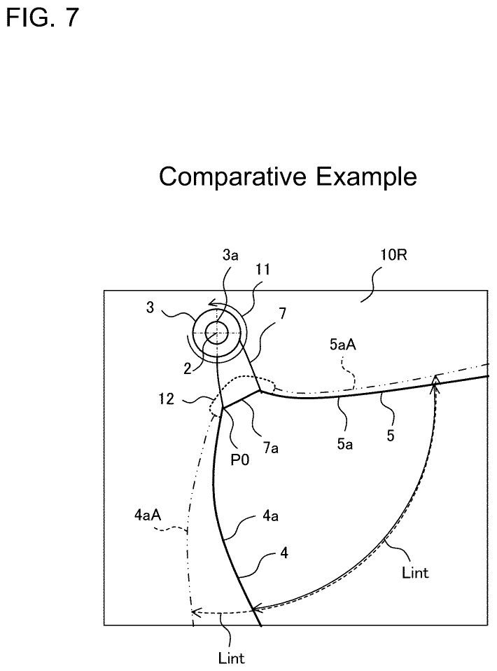

FIG. 7 illustrates stress concentration in the axial fan 10R according to Comparative Example. The axial fan 10R rotates in the rotational direction 11 around the central axis defined by the fan shaft 2. A centrifugal force generated during rotation of the axial fan 10R causes deformation of the blade 1. In FIG. 7, a chain double-dashed line 5aA represents the position of the edge 5a when the blade 1 is under deformation, and a chain double-dashed line 4aA represents the position of the edge 4a when the blade 1 is under deformation. As illustrated in FIG. 7, the inter-edge separation Lint between the edge 5a and the edge 4a when the blade 1 is under deformation is greater than the inter-edge separation Lint under normal conditions. As can be appreciated, the centrifugal force generated during rotation of the axial fan 10R causes the inter-edge separation Lint to increase. In this case, deformation of the leading edge part 4 and the trailing edge part 5 of the blade 1 induces localized stress around the connection part 7 located at the root of the blade 1. That is, stress concentrates in a region 12 in the vicinity of the edge 7a of the connection part 7 as illustrated in FIG. 7. This may lead to breakage of the blade 1 or breakage of the connection part 7.

### [Stress Distribution Part 8 of Axial Fan 10 According to Embodiment 1]

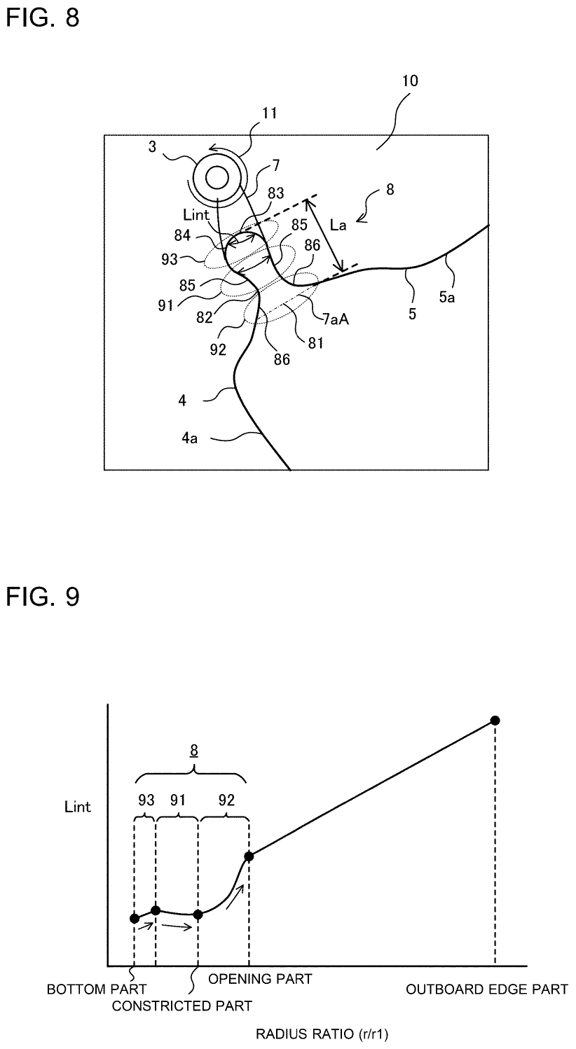

The description returns to explanation of Embodiment 1. In the axial fan 10 according to Embodiment 1, the connection part 7 includes the stress distribution part 8 as illustrated in FIG. 1 to distribute stress that concentrates in the region 12 in the vicinity of the edge 7a of the connection part 7. FIG. 8 is a front view of the stress distribution part 8 provided to the axial fan 10 according to Embodiment 1. The alternate long and short dashed line in FIG. 8 corresponds to the imaginary line 7aA, which represents the position of the edge 7a of the connection part 7 described above with reference to Comparative Example illustrated in FIGS. 4 to 7. As illustrated in FIG. 1, in front view, the imaginary line 7aA may for instance be a smooth extension of a portion of the edge 5a of the trailing edge part 5 of the blade 1, the portion being near the leading edge part 4 of the trailing blade 1, which is the blade located further rearward in the rotational direction 11 than the above-mentioned blade 1 and circumferentially adjacent to the above-mentioned blade 1. In any case, the region inboard of the imaginary line 7aA corresponds to the area where the connection part 7 is located (see the arrows 24 in FIG. 15).

As illustrated in FIGS. 1 and 8, the stress distribution part 8 is a cut made in the connection part 7. The blade 1 and the connection part 7 of the axial fan 10 are formed for instance by resin injection molding. This means that the stress distribution part 8 can be formed simultaneously with injection molding of the blade 1 and the connection part 7. Alternatively, the stress distribution part 8 may be provided to the connection part 7 after the blade 1 and the connection part 7 are formed. The stress distribution part 8 is a substantially U-shaped recess extending inboard from an outboard end portion 71 defining the edge 7a at the outboard part of the connection part 7. The stress distribution part 8 extends through the material thickness of the connection part 7. The stress distribution part 8 includes an opening part 81, a constricted part 82, and a bottom part 83. As illustrated in FIG. 8, the total radial length of the stress distribution part 8 is defined as “length La.” That is, the length La is the radial length from the opening part 81 to the bottom part 83 of the stress distribution part 8. As described above, the stress distribution part 8 is in the form of a cut made to extend through the material thickness of the connection part 7. The region where the stress distribution part 8 is present thus defines a discontinuous part in the connection part 7.

The opening part 81 is provided at the position of the imaginary line 7aA, which represents the position of the edge 7a of the connection part 7 described above with reference to Comparative Example illustrated in FIGS. 4 to 7. According to Embodiment 1, the opening part 81 is provided along the entire circumferential length of the imaginary line 7aA, but this is not necessarily the case. That is, the opening part 81 may be provided along only a portion of the imaginary line 7aA. In this case, an area represented by the imaginary line 7aA adjacent to the opening part 81 of the stress distribution part 8 defines a shoulder part. In this case, impinging of air on the shoulder part causes turbulence in the flow of air, leading to a pressure loss. It is thus desirable that the opening part 81 be provided along the entire circumferential length of the imaginary line 7aA. Consequently, as illustrated in FIG. 8, in the vicinity of the opening part 81, the edges of the stress distribution part 8 are smoothly joined to the edge 4a of the leading edge part 4 and the edge 5a of the trailing edge part 5 of the blade 1. This helps to reduce a pressure loss of air flowing in the vicinity of the opening part 81.

The bottom part 83 corresponds to the innermost portion of the stress distribution part 8. That is, the bottom part 83 is a portion of the stress distribution part 8 closest to the fan shaft 2. The bottom part 83 is located radially opposite to the opening part 81. An inner portion of the stress distribution part 8 including the bottom part 83 defines an arcuate part 84 having an arcuate shape. The edge of the arcuate part 84 has for instance a semicircular or substantially semicircular shape. The edge of the arcuate part 84 is thus formed as a curve with a single curvature or a plurality of curvatures.

The constricted part 82 is located between the opening part 81 and the bottom part 83 in the radial direction. Although the constricted part 82 may be located at any position along the radial length La, it is desirable that the constricted part 82 be located further outboard than the midpoint (=La/2) of the length La. The constricted part 82 is a part that is constricted circumferentially inward. In the circumferential direction, the constricted part 82 thus has a length less than each of the length of the arcuate part 84 and the length of the opening part 81. That is, among different “inter-edge separations Lint” across the stress distribution part 8, the “inter-edge separation Lint” in the constricted part 82 is the smallest.

A first inclined part 85 is provided between the arcuate part 84 and the constricted part 82. The first inclined part 85 is tapered. That is, in the first inclined part 85, the “inter-edge separation Lint” decreases gradually in a direction from the arcuate part 84 toward the constricted part 82. A region of the stress distribution part 8 defined by the first inclined part 85 and extending from the arcuate part 84 to the constricted part 82 is hereinafter referred to as first region 91. The first region 91 is a region where the “inter-edge separation Lint” decreases in the radially outboard direction.

A second inclined part 86 is provided between the constricted part 82 and the opening part 81. The second inclined part 86 is oppositely tapered. That is, in the second inclined part 86, the “inter-edge separation Lint” increases gradually in a direction from the constricted part 82 toward the opening part 81. A region of the stress distribution part 8 defined by the second inclined part 86 and extending from the constricted part 82 to the opening part 81 is hereinafter referred to as second region 92. The second region 92 is a region where the “inter-edge separation Lint” increases in the radially outboard direction. The boundary between the first region 91 and the second region 92 corresponds to the constricted part 82.

The region corresponding to the arcuate part 84 is referred to as third region 93 of the stress distribution part 8. The third region 93 is a region where the “inter-edge separation Lint” increases gradually in the radially outboard direction from the bottom part 83.

The edges of the entire substantially U-shaped stress distribution part 8, including the edges in the first region 91, the edges in the second region 92, and the edges in the third region 93, are hereinafter referred to as edges 8a of the stress distribution part 8. The “inter-edge separation Lint” in the stress distribution part 8 is sometimes referred to herein as first inter-edge separation.

FIG. 9 is an explanatory drawing illustrating variation of the inter-edge separation Lint in the radial direction in the stress distribution part 8 of the axial fan 10 according to Embodiment 1. In FIG. 9, the vertical axis represents the inter-edge separation Lint, and the horizontal axis represents a radius ratio, which is defined as the ratio, to the radius r1, of the radius r of a circle concentric with the circle of the radius r1. It can be appreciated from FIG. 9 that in the first region 91, the inter-edge separation Lint decreases gradually in the radially outboard direction. It can be also appreciated that in the second region 92, the inter-edge separation Lint increases gradually in the radially outboard direction. The rate of change (the absolute value of the rate of decrease) of the inter-edge separation Lint in the first region 91 is less than the rate of change (the absolute value of the rate of increase) of the inter-edge separation Lint in the second region 92. It can be also appreciated that in the third region 93, the inter-edge separation Lint increases gradually in the radially outboard direction. The rate of change (the absolute value of the rate of decrease) of the inter-edge separation Lint in the first region 91 is less than the rate of change (the absolute value of the rate of increase) of the inter-edge separation Lint in the third region 93.

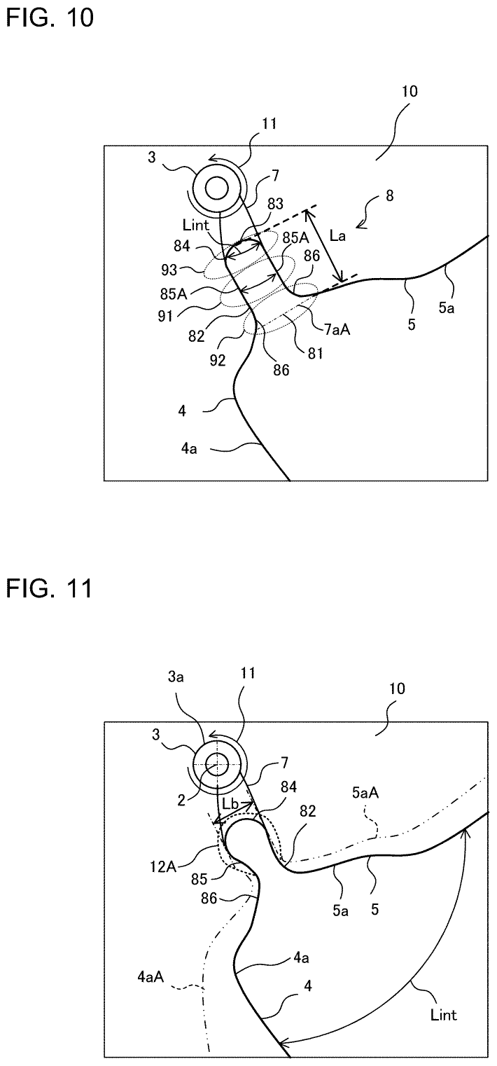

Although the foregoing description is directed to a case where, in the first region 91, the inter-edge separation Lint decreases gradually in the radially outboard direction, this is not necessarily the case. FIG. 10 is a partial front view of a modification of the axial fan 10 according to Embodiment 1. In FIG. 10, the inter-edge separation Lint in the first region 91 is constant. That is, in FIG. 10, the stress distribution part 8 includes a pair of straight parts 85A instead of the first inclined part 85. The straight parts 85A are disposed in parallel to each other. In the first region 91 defined by the straight parts 85A, the inter-edge separation Lint does not change but remains constant. The stress distribution part 8 according to the modification illustrated in FIG. 10 is similar in function to the stress distribution part 8 according to Embodiment 1. Therefore, the modification illustrated in FIG. 10 provides advantageous effects similar to those of Embodiment 1. Advantageous Effects of Embodiment 1 are described below.

### Advantageous Effects of Embodiment 1

FIG. 11 illustrates a stress distribution effect in the axial fan 10 according to Embodiment 1. The axial fan 10 rotates in the rotational direction 11 around the central axis defined by the fan shaft 2. A centrifugal force generated during rotation of the axial fan 10 causes deformation of the blade 1. In FIG. 11, the chain double-dashed line 5aA represents the position of the edge 5a when the blade 1 is under deformation, and the chain double-dashed line 4aA represents the position of the edge 4a when the blade 1 is under deformation. As can be appreciated, a centrifugal force generated during rotation of the axial fan 10 causes the blade 1 to deform such that the inter-edge separation Lint increases. At this time, according to Comparative Example, the greatest stress concentration occurs in the region 12 in the vicinity of the edge 7a of the connection part 7 as described above with reference to FIG. 7. In this regard, according to Embodiment 1, the connection part 7 includes the stress distribution part 8. According to Embodiment 1, as illustrated in FIG. 11, stress acts on a region 12A located along the edges 8a of the stress distribution part 8. Since the stress distribution part 8 is defined by a substantially U-shaped cut made in the edge 7a of the connection part, the length of the edges 8a of the stress distribution part 8 is greater than the length of the edge 7a of the connection part according to Comparative Example. Accordingly, the region 12A located along the edges 8a of the stress distribution part 8 is larger in extent than the region 12 located along the edge 7a of the connection part 7 according to Comparative Example. This means that, although stress is concentrated in the region 12 according to Comparative Example illustrated in FIG. 7, stress is distributed across the entirety of the region 12A, which is larger in extent than the region 12. Therefore, Embodiment 1 allows for reduced stress concentration in comparison to Comparative Example.

The stress distribution part 8 includes the constricted part 82. This makes it possible to mitigate an increase in the inter-edge separation Lint during deformation of the blade 1, and consequently ensure sufficient strength of the connection part 7. In the stress distribution part 8, the first region 91 is located further inboard than the constricted part 82. In the first region 91, the inter-edge separation Lint decreases gradually in the radially outboard direction. Accordingly, in addition to a stress applied in a direction that causes the inter-edge separation Lint to increase as represented by the chain double-dashed lines 4aA and 5aA in FIG. 11, an oppositely directed force is applied by the first region 91 to cancel the stress out. A stress distribution effect for the first region 91 can be thus expected. That is, the presence of the first inclined part 85 (see FIG. 8) or the straight part 85A (see FIG. 10) that defines the first region makes it possible to distribute stress.

In the stress distribution part 8, the second region 92 is located further outboard than the first region 91. In the second region 92, the inter-edge separation Lint increases gradually in the radially outboard direction. Providing the second region 92 as described above to increase the opening angle of the cut defining the stress distribution part 8 allows for reduced stress concentration factor. A stress concentration factor refers to the ratio between the maximum possible localized stress, and the mean stress on the cross-section of interest (also referred to as nominal stress).

In the stress distribution part 8, the third region 93 defined by the arcuate part 84 is located further inboard than the first region. The arcuate part 84 has a semicircular or substantially semicircular shape. The presence of the arcuate part 84 described above allows for increased radius of the bottom part 83, which helps to reduce the stress concentration factor. As for a diameter Lb (see FIG. 11) of the arcuate part 84, both too large a diameter Lb and too small a diameter Lb relative to the radial length La (see FIG. 8) of the stress distribution part 8 lead to a reduced stress distribution effect. It is thus desirable that the diameter Lb of the arcuate part 84 be about one-half or one-third of the radial length La (see FIG. 8) of the stress distribution part 8. Further, the arcuate part 84 has a curved shape, which means that the arcuate part 84 is joined smoothly to the edges in the first region 91. This helps to reduce stress concentration.

In FIG. 1, arrows 9 each represent a flow of air over the front side of the blade 1 during rotation of the blade 1. The front side of the blade 1 is defined as the side that pushes the airflow on the surface of the blade 1, that is, the stress side. Likewise, for Comparative Example illustrated in FIG. 4, the arrows 9 each represent a flow of air over the front side of the blade 1 during rotation of the blade 1. According to Comparative Example, as represented by the arrows 9 in FIG. 4, air flows along the front side of the blade 1 in generally the same manner from the leading edge part 4 toward the trailing edge part 5. In this regard, according to Embodiment 1, the connection part 7 includes the stress distribution part 8 as illustrated in FIG. 1. As illustrated in the graph in FIG. 9, the inter-edge separation Lint is thus significantly reduced in the first to third regions 91 to 93 where the stress distribution part 8 is provided, in comparison to other areas from the opening part 81 to the outboard edge part 6. Since an airflow increases its velocity when passing through a narrow gap, the above-mentioned configuration allows the blade 1 to do increased work on the entire airflow in the first to third regions 91 to 93 where the stress distribution part 8 is provided. As a result, as represented by the arrows 9 in FIG. 1, the region where the stress distribution part 8 is provided serves to draw in airflow from near the outboard part of the blade 1. This helps to facilitate inflow of air toward the inboard part of the blade 1 for the axial fan 10 as a whole. As previously mentioned, the air-sending efficiency of an axial fan is generally known to increase with increasing inboard-directed flow of air. This means that according to Embodiment 1, the presence of the stress distribution part 8 also provides the effect of increasing air-sending efficiency.

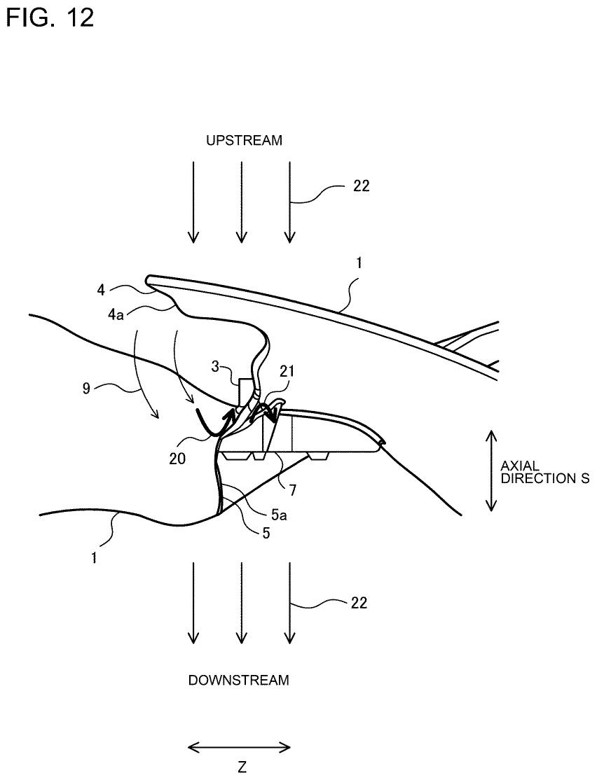

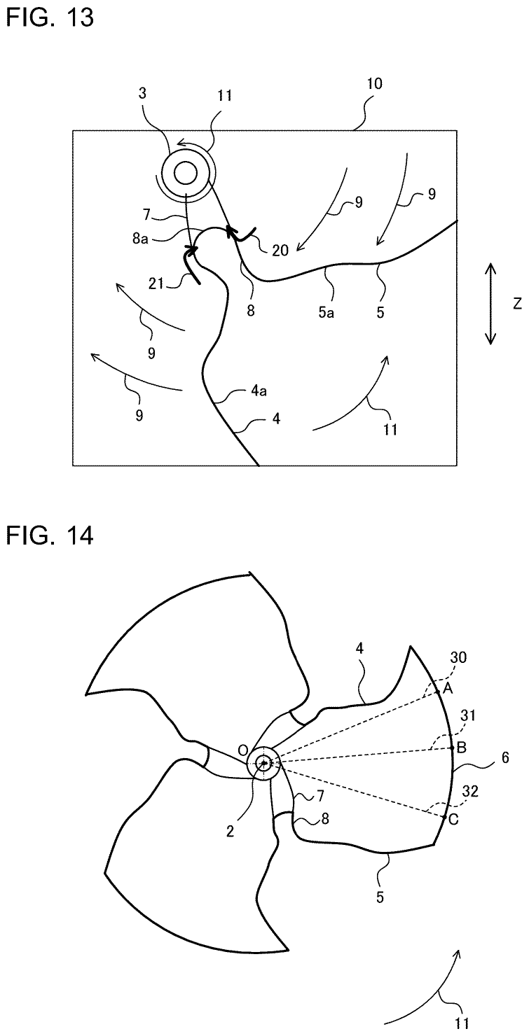

FIG. 12 is a partial enlarged side view of the axial fan 10 according to Embodiment 1, illustrating the flow of air at the connection part 7 of the axial fan 10. FIG. 13 is a partial enlarged front view of the axial fan 10 according to Embodiment 1, illustrating the flow of air at the connection part 7 of the axial fan 10. In FIGS. 12 and 13, an arrow 20 represents an airflow at an edge of the connection part 7 joined to the edge 5a of the trailing edge part 5, that is, an airflow at the edge 8a of the stress distribution part 8 joined to the edge 5a of the trailing edge part 5 (referred to as “edge 8a near the trailing edge part 5” hereinafter). An arrow 21 represents an airflow at an edge of the connection part 7 joined to the edge 4a of the leading edge part 4, that is, an airflow at the edge 8a of the stress distribution part 8 joined to the edge 4a of the leading edge part 4 (referred to as “edge 8a near the leading edge part 4” hereinafter).

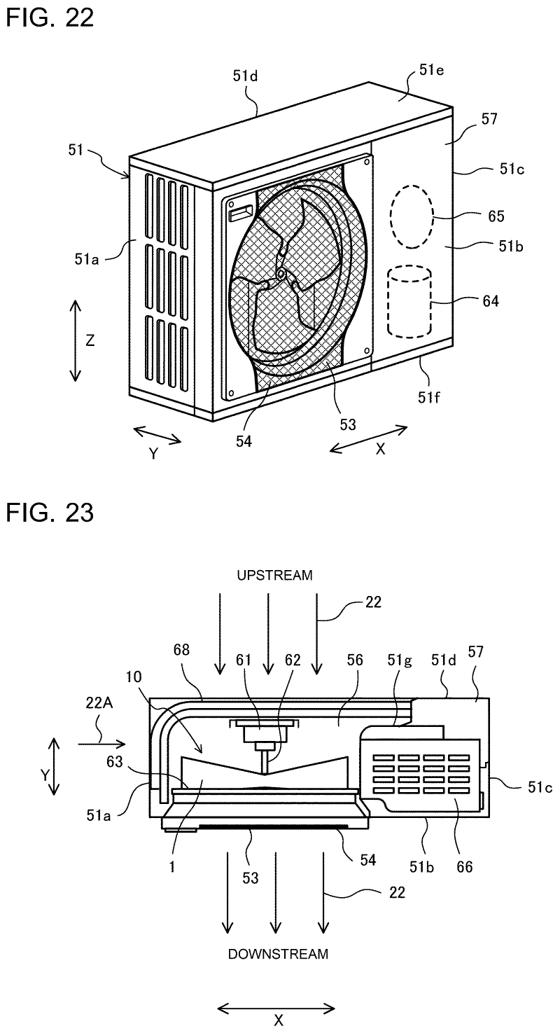

As indicated by the arrow 20 in FIGS. 12 and 13, at the edge 8a near the trailing edge part 5, the airflow either deflects in a height direction Z (see FIG. 22), or changes directions from downstream to upstream in the axial direction S. That is, as represented by the arrow 20, the airflow changes directions such that the airflow is directed from the front side of the blade 1 toward the back side.

As indicated by the arrow 21 in FIGS. 12 and 13, at the edge 8a near the leading edge part 4, the airflow either deflects in the height direction Z (see FIG. 22), or changes directions from upstream to downstream in the axial direction S. That is, as represented by the arrow 21, the airflow changes directions such that the airflow is directed from the back side of the blade 1 toward the front side.

As described above, the direction of airflow is different between the area in the vicinity of the edge 8a near the leading edge part 4, and the area in the vicinity of the edge 8a near the trailing edge part 5. That is, at the stress distribution part 8 defined by a cut, the airflow is divided into separate portions, one flowing near the leading edge part 4 and another flowing near the trailing edge part 5. The division of the airflow results in reduced stress imposed on the blade 1 by the airflow. As a result, the stress imposed on the blade 1 by the airflow is reduced, leading to reduced deformation of the blade 1.

FIGS. 14 and 15 are explanatory drawings each illustrating the shape of the blades 1 of the axial fan 10 according to Embodiment 1. FIG. 14 is a front view of the axial fan 10 according to Embodiment 1. In FIG. 14, a point O represents the position of the fan shaft 2. In FIG. 14, a point A, a point B, and a point C represent three points on the outboard edge part 6 of the blade 1. Of the three points, the point A is the point closest to the leading edge part 4, and the point C is the point closest to the trailing edge part 5. The point B is the point midway between the point A and the point C.

A cross-section 30 in FIG. 15 is a cross-section along a straight line AO connecting the point A and the point O in FIG. 14. A cross-section 31 in FIG. 15 is a cross-section along a straight line BO connecting the point B and the point O in FIG. 14. A cross-section 32 in FIG. 15 is a cross-section along a straight line CO connecting the point C and the point O in FIG. 14. In FIG. 15, a point 30a represents the most upstream position on the cross-section 30, a point 31a represents the most upstream position on the cross-section 31, and a point 32a represents the most upstream position on the cross-section 32.

In FIG. 15, arrows 22 each represent an airflow generated as the axial fan 10 rotates. As indicated by the arrows 22, rotation of the axial fan 10 generates an airflow directed from an upstream location toward a downstream location. According to Embodiment 1, the connection part 7 of the axial fan 10 includes the stress distribution part 8. As a result, as represented by an arrow 23 in FIG. 15, inflow of air toward the inboard part of the axial fan 10 represented by the arrows 22 is facilitated. In FIG. 15, the arrows 24 represent an area of the axial fan 10 where the connection part 7 is provided. As described above, Embodiment 1 facilitates inflow of air into the area of the axial fan 10 represented by the arrows 24 where the connection part 7 is provided. As illustrated in FIG. 15, it is desirable that the radial length La of the stress distribution part 8 (see FIG. 8) be equal to one-half or greater than one-half the radius r0 (see FIG. 4) corresponding to the area where the connection part 7 is provided.

As described above, according to Embodiment 1, the connection part 7 includes the stress distribution part 8. This helps to distribute the stress generated during rotation of the axial fan 10. The resulting ability to reduce concentration of stress at the connection part 7 makes it possible to prevent the blade 1 and the connection part 7 from breaking when strong wind such as in a typhoon impacts. The presence of the stress distribution part 8 also helps to facilitate inflow of air toward the inboard part of the axial fan 10. This in turn helps to improve air-sending capability. Further, the blade 1 and the connection part 7 do not need to be increased in material thickness in the vicinity of the fan shaft 2 to ensure sufficient strength. This makes it possible to maintain a weight reduction effect, which is an advantage provided by the boss-less construction. As described above, the axial fan 10 according to Embodiment 1 makes it possible to ensure compatibility between an advantage provided by the boss-less construction (i.e., reduced weight and improved air-sending efficiency of the axial fan 10), and maintaining of the strength of the blades 1.

### Embodiment 2

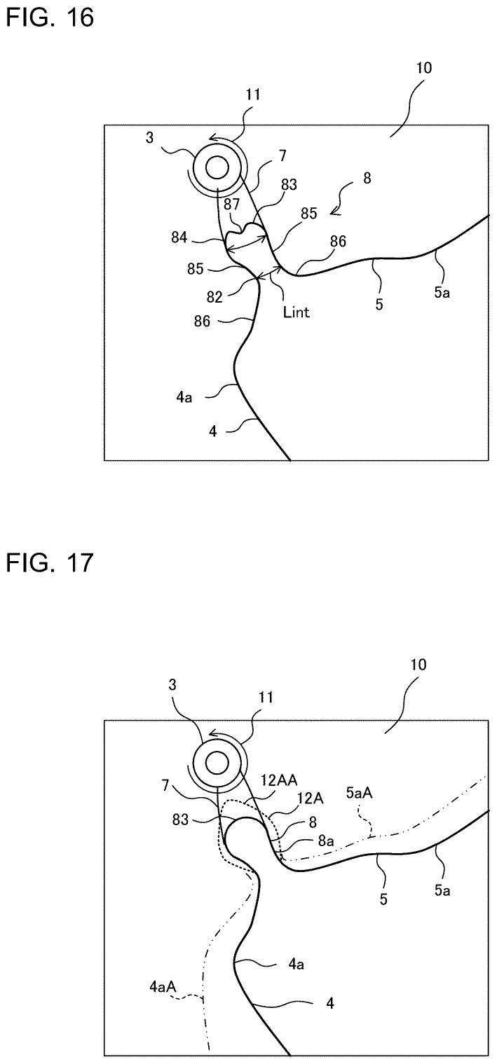

FIG. 16 is a front view of the axial fan 10 according to Embodiment 2. Embodiment 2 differs from Embodiment 1 illustrated in FIG. 8 in that, as illustrated in FIG. 16, a projection 87 is provided to the bottom part 83 of the stress distribution part 8. Other features of Embodiment 2 are the same as those of Embodiment 1, and thus designated by the same reference signs used for Embodiment 1 and not described here in further detail.

As illustrated in FIG. 16, the projection 87 is provided to the bottom part 83 of the stress distribution part 8. The projection 87 projects outboard from the bottom part 83 of the stress distribution part 8. The edge 8a at the location of the projection 87 is referred to as edge 8aa. In this case, the edge Baa of the projection 87 is in the form of a curve with a single curvature or a plurality of curvatures. According to Embodiment 2 as well, the blade 1 and the connection part 7 of the axial fan 10 are formed for instance by resin injection molding. This means that the stress distribution part 8 including the projection 87 can also be formed simultaneously with injection molding of the blade 1 and the connection part 7. Alternatively, the stress distribution part 8 including the projection 87 may be provided to the connection part 7 after the blade 1 and the connection part 7 are formed.

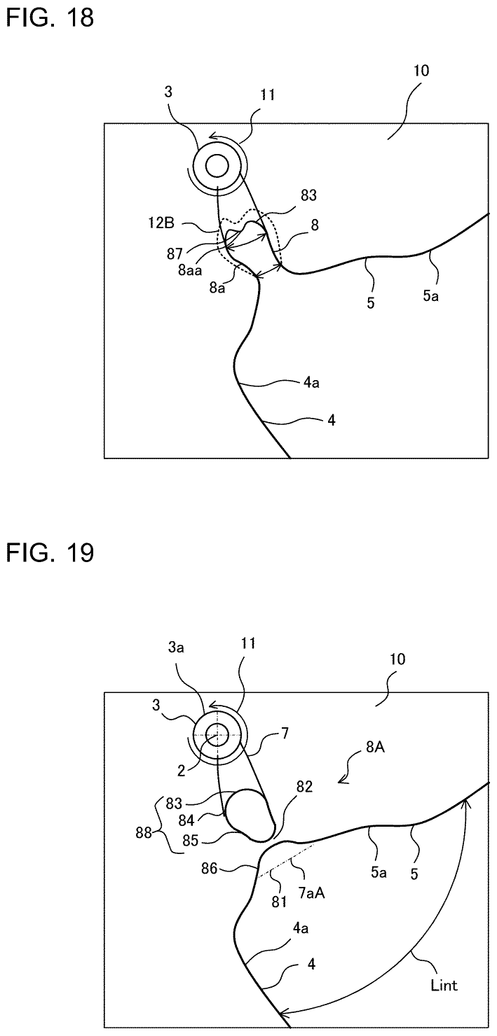

FIG. 17 is a reference drawing illustrating an example of how stress is distributed in the stress distribution part 8 of the axial fan 10 according to Embodiment 1 described above. By contrast, FIG. 18 is an explanatory drawing illustrating an example of how stress is distributed in the stress distribution part 8 of the axial fan 10 according to Embodiment 2. In FIG. 18, a region 12B represents a region that lies along the edges 8a of the stress distribution part 8, and that serves to distribute stress. That is, according to Embodiment 2, the stress generated during rotation of the axial fan 10 is distributed across the entirety of the region 12B. This is described in detail below.

According to Embodiment 1 described above, as illustrated in FIG. 11, the stress generated during rotation of the axial fan 10 is distributed across the entirety of the region 12A. The region 12A is a region along the edges 8a of the stress distribution part 8. However, situations are conceivable where due to, for instance, environmental changes such as typhoons, or the shape of the blade 1, the stress is not distributed uniformly across the entirety of the region 12A, resulting in an uneven stress distribution as indicated by the region 12A illustrated in the reference diagram of FIG. 17. In FIG. 17, of the region 12A, a region 12AA is subjected to greater stress than other portions. The region 12AA is a portion of the region 12A closest to the shaft support 3.

To address this, according to Embodiment 2, the bottom part 83 of the stress distribution part 8 includes the projection 87. As a result, the edges 8a of the stress distribution part 8 are extended radially outboard at the bottom part 83. That is, the edges 8a according to Embodiment 2 are extended and longer than the edges 8a according to Embodiment 1 by a length corresponding to the added length of the edge Baa of the projection 87. The edge 8aa is in the form of a curve, and joined smoothly to other portions of the edges 8a. That is, the edge 8a is joined smoothly to the edges 8a in the first region 91 (see FIG. 10) of the stress distribution part 8. Consequently, as indicated by the region 12B in FIG. 18, according to Embodiment 2, the edges 8a are extended in length as a whole by an amount corresponding to the projection 87. As a result, the region serving to distribute stress is enlarged in comparison to Embodiment 1. Embodiment 2 therefore allows for an improved stress distribution effect in comparison to Embodiment 1.

As described above, with the axial fan 10 according to Embodiment 2, as with Embodiment 1, the presence of the stress distribution part 8 makes it possible to ensure compatibility between an advantage provided by the boss-less construction (i.e., reduced weight and improved air-sending efficiency of the axial fan 10), and maintaining of the strength of the blades 1. Further, according to Embodiment 2, the projection 87 is provided to the bottom part 83 of the stress distribution part 8. This results in a corresponding increase in the length of the edges 8a of the stress distribution part 8. Consequently, the region serving to distribute stress is further enlarged, which allows for an improved stress distribution effect in comparison to Embodiment 1.

### Embodiment 3

FIG. 19 is a partial front view of the axial fan 10 according to Embodiment 3. Embodiment 3 differs from Embodiment 1 illustrated in FIG. 8 in that, as illustrated in FIG. 19, the inter-edge separation Lint in the constricted part 82 of the stress distribution part 8 is 0 mm. That is, in Embodiment 1, the inter-edge separation Lint in the constricted part 82 of the stress distribution part 8 is greater than 0 mm, whereas in Embodiment 3, the edges in the constricted part 82 are joined together such that the separation Lint is 0 mm. That is, the constricted part 82 is a joined part. As a result, the arcuate part 84 and the first inclined part 85 define a through-hole provided to the connection part 7. As described above, the inter-edge separation Lint in the constricted part 82 may be greater than or equal to 0 mm.

As described above, according to Embodiment 3, instead of the stress distribution part 8 defined by a cut described above with reference to Embodiments 1 and 2, a stress distribution part 8A defined by a through-hole is provided. The stress distribution part 8A includes a through-hole 88, the constricted part 82, which is a joined part, the second inclined part 86, and the opening part 81. As described above, according to Embodiment 3, as with Embodiment 1, the connection part 7 defined by a continuous surface is partially formed into a discontinuous part that defines the stress distribution part 8A. Other features of Embodiment 3 are the same as those of Embodiment 1, and thus designated by the same reference signs used for Embodiment 1 and not described here in further detail.

According to Embodiment 3, the periphery of the through-hole 88, the periphery of the second inclined part 86, and the periphery of the opening part 81 define the edges 8a of the stress distribution part 8A. This means that the stress generated during rotation of the axial fan 10 is distributed across the entirety of the region extending along the edges 8a of the stress distribution part 8A, Embodiment 3 therefore provides advantageous effects similar to those of Embodiments 1 and 2.

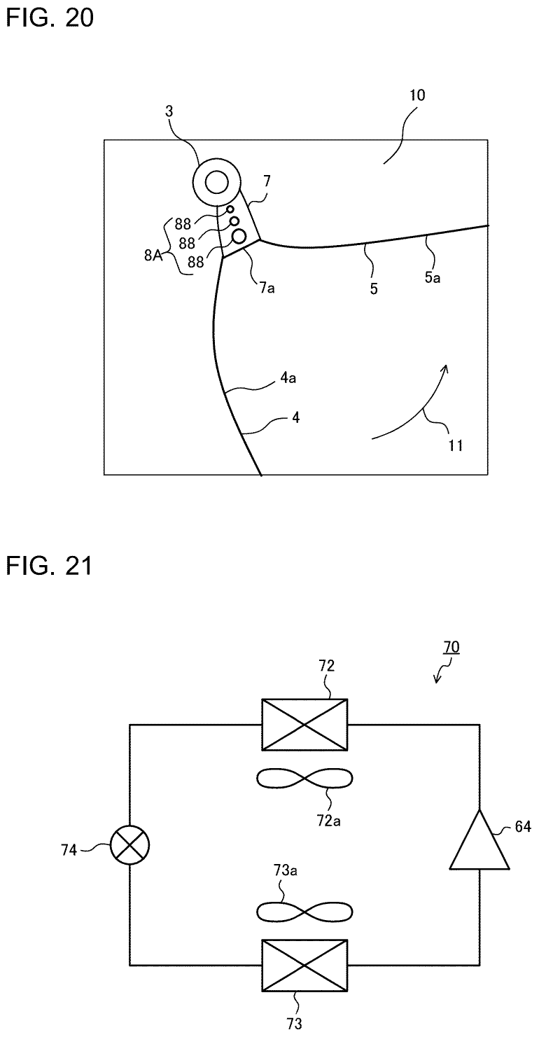

FIG. 20 is a partial front view of a modification of the axial fan 10 according to Embodiment 3. As in the modification illustrated in FIG. 20, the stress distribution part 8A may include a plurality of through-holes 88. The stress distribution part 8A is disposed in the connection part 7. If the stress distribution part 8A includes a plurality of through-holes 88, the through-holes 88 may be arranged side by side in the radial direction in the connection part 7 as illustrated in FIG. 20. The through-holes 88 do not have to be equal in size. Specifically, as illustrated in FIG. 20, the outboard one of the through-holes 88 may be the largest, with the through-holes 88 becoming gradually smaller in a direction from the outboard part toward the inboard part. In the example in FIG. 20, the stress distribution part 8A is made up of only a plurality of through-holes 88. That is, in the example in FIG. 20, the stress distribution part 8A includes neither the second inclined part 86 nor the opening part 81. In the case of the modification in FIG. 20, the stress generated during rotation of the axial fan 10 is distributed across the entire region extending along the periphery of the through-holes 88.

According to Embodiment 3 and its modification, the connection part 7 includes the stress distribution part 8A defined by the through-hole 88. As a result, the stress generated during rotation of the axial fan 10 is distributed across the entire connection part 7.

As described above, the axial fan 10 according to Embodiment 3 provides advantageous effects similar to those of Embodiments 1 and 2. That is, according to Embodiment 3, the presence of the stress distribution part 8A makes it possible to ensure compatibility between an advantage provided by the boss-less construction (i.e., reduced weight and improved air-sending efficiency of the axial fan 10), and maintaining of the strength of the blades 1.

### Embodiment 4

Although the foregoing description of the axial fan 10 according to each of Embodiments 1 to 3 is directed to distribution of stress on an axial fan of the boss-less type, mounting the axial fan 10 to an air-sending device allows the air-sending device to send an increased amount of air with high efficiency. Mounting the axial fan 10 to an air-conditioning apparatus or water-heating outdoor unit, which is a refrigeration cycle apparatus including a compressor, a heat exchanger, and other components, makes it possible to gain an amount of airflow through the heat exchanger with high efficiency, and consequently achieve energy saving of such an apparatus. Embodiment 4 is directed to one such example of a case where the axial fan 10 according to each of Embodiments 1 to 3 is employed for an outdoor unit of an air-conditioning apparatus, which represents an outdoor unit including an air-sending device.

FIG. 21 is a schematic diagram of an air-conditioning apparatus representing a refrigeration cycle apparatus according to Embodiment 4. As illustrated in FIG. 21, the air-conditioning apparatus includes a refrigerant circuit 70 formed by connecting a compressor 64, a condenser 72, an expansion valve 74, and an evaporator 73 in this order by refrigerant pipes. A condenser fan 72a, which is a fan used for the condenser, is disposed at the condenser 72. The condenser fan 72a sends air used for heat exchange to the condenser 72. An evaporator fan 73a, which is a fan used for the evaporator, is disposed at the evaporator 73. The evaporator fan 73a sends air used for heat exchange to the evaporator 73. At least one of the condenser fan 72a and the evaporator fan 73a is the axial fan 10 according to any one of Embodiments 1 to 3 mentioned above. The refrigerant circuit 70 may be provided with a device such as a four-way valve to allow switching between a heating operation and a cooling operation.

FIG. 22 is a perspective view, as viewed from near an air outlet, of an outdoor unit representing an example of an air-sending device according to Embodiment 4. FIG. 23 is an explanatory top view of the outdoor unit illustrated in FIG. 22. In FIGS. 22 and 23, X denotes width direction, Y denotes depth direction, and Z denotes height direction. The height direction Z is, for example, a vertical direction or a substantially vertical direction.

As illustrated in FIGS. 22 and 23, an outdoor unit body 51 serving as a casing is in the form of as an enclosure having the following surfaces: a side surface 51a and a side surface 51c, which define a pair of left and right side surfaces; a front surface 51b; a back surface 51d; a top surface 51e; and a bottom surface 51f. The side surface 51a and the back surface 51d each have an opening for sucking in air from outside. The front surface 51b includes an air outlet 53 defined in a front panel 52. The air outlet 53 serves as an opening through which to blow air to outside. Further, the air outlet 53 is covered with a fan grille 54 to ensure safety by preventing contact between the axial fan 10 and, for example, an external object. Arrows 22, and an arrow 22A in FIG. 23 each represent flow of air.

The axial fan 10 is installed inside the outdoor unit body 51. The axial fan 10 is connected to the fan motor 61, which is a drive source located near the back surface 51d by use of the drive shaft 62 in between. The axial fan 10 is configured to be driven to rotate with a driving force provided by the fan motor 61. The drive shaft 62 extends in a direction perpendicular to the height direction Z. In the example in FIG. 22, the drive shaft 62 extends in the depth direction Y.

The interior of the outdoor unit body 51 is divided by a partition plate 51g, which is a wall element, into an air-sending chamber 56 in which the axial fan 10 is installed, and a machine chamber 57 in which the compressor 64 and other components are installed. A heat exchanger 68, such as one extending in a substantially L-shape in plan view, is disposed at a location within the air-sending chamber 56 and near the side surface 51a and near the back surface 51d. The heat exchanger 68 acts as the condenser 72 during cooling operation, and acts as the evaporator 73 during heating operation.

A bell mouth 63 is disposed radially outward of the axial fan 10 disposed in the air-sending chamber 56. The bell mouth 63 is located further outward than the outboard end of the blade 1, and defines an annular shape in the rotational direction of the axial fan 10. The partition plate 51g is located beside one side of the bell mouth 63, and a portion of the heat exchanger 68 is located beside the other side of the bell mouth 63.

The front end of the bell mouth 63 is connected to the front panel 52 of the outdoor unit such that the front end surrounds the periphery of the air outlet 53. The bell mouth 63 may be integral with the front panel 52, or may be provided as a separate component and joined to the front panel 52. Due to the presence of the bell mouth 63, the flow passage between the inlet side and the outlet side of the bell mouth 63 is defined as an air passageway near the air outlet 53. That is, the air passageway near the air outlet 53 is partitioned off by the bell mouth 63 from other spaces within the air-sending chamber 56.

The heat exchanger 68 disposed near the air inlet of the axial fan 10 includes the following components: a plurality of fins with plate-like surfaces arranged side by side in parallel to each other; and heat transfer tubes penetrating the fins in a direction in which the fins are arranged side by side. Refrigerant that circulates in the refrigerant circuit flows in the heat transfer tubes. In the heat exchanger 68 according to Embodiment 4, a plurality of rows of heat transfer tubes extend in an L-shape over an area of the outdoor unit body 51 including the side surface 51a and the back surface 51d, and follow a meandering path while penetrating the fins. The heat exchanger 68 is connected to the compressor 64 by use of a pipe 65 or other components in between, and is further connected to unillustrated components such as an indoor-side heat exchanger and the expansion valve to form the refrigerant circuit 70 of the air-conditioning apparatus. A board case 66 is disposed in the machine chamber 57. A control board (not illustrated) disposed in the board case 66 is configured to control devices mounted in the outdoor unit.

Embodiment 4 provides advantageous effects similar to those of Embodiments 1 to 3 corresponding to Embodiment 4.

### Embodiment 5

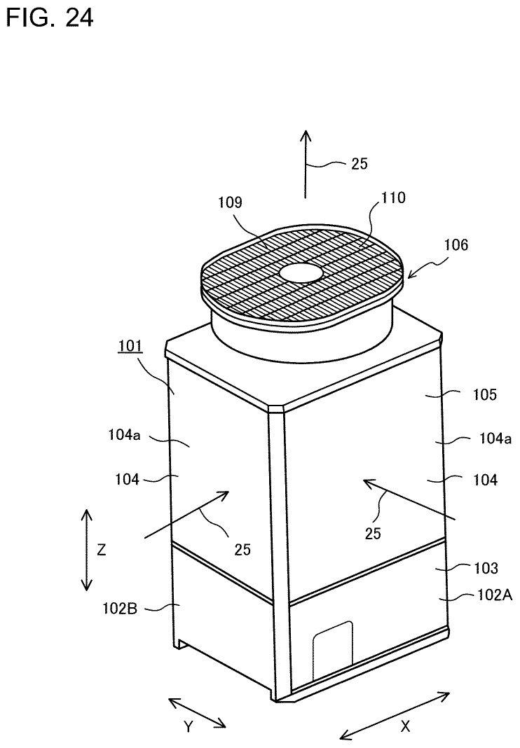

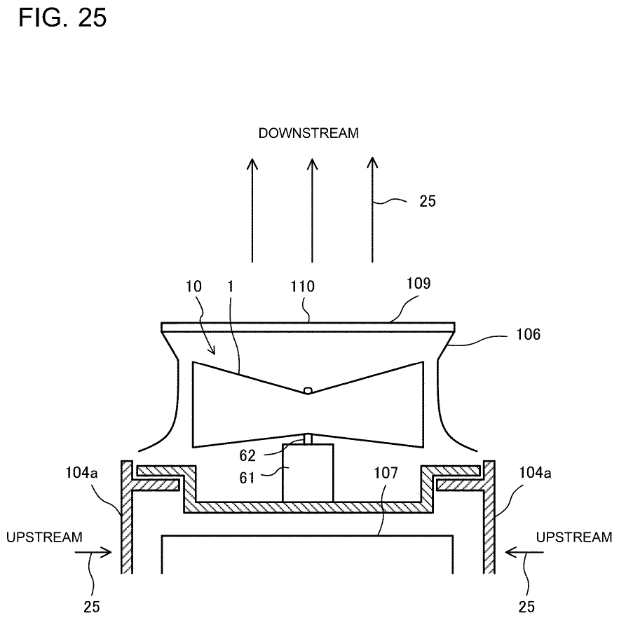

FIG. 24 is a perspective view of an outdoor unit representing an example of an air-sending device according to Embodiment 5. FIG. 25 is an explanatory partial cross-sectional view of the outdoor unit illustrated in FIG. 24.

Although the foregoing description of Embodiment 4 is directed to a side-flow outdoor unit configured to blow air horizontally, this is not intended to be limiting. For example, it is also possible to employ the axial fan 10 according to each of Embodiments 1 to 3 for a top-flow outdoor unit configured to blow air upward, such as an outdoor unit of a large air-conditioning apparatus used for a building. As illustrated in FIG. 25, in the outdoor unit according to Embodiment 5, the axial fan 10 is mounted with the front of the axial fan 10 facing up in the vertical direction or substantially vertical direction. The fan motor 61 serving as a drive source is thus disposed vertically below the axial fan 10. The drive shaft 62 of the fan motor 61 extends in the vertical direction or substantially vertical direction. The axial fan 10 is connected to the fan motor 61 serving as a drive source by use of the drive shaft 62 in between. The axial fan 10 is configured to be driven to rotate with a driving force provided by the fan motor 61.

As illustrated in FIGS. 24 and 25, the outdoor unit according to Embodiment 5 includes a body case 101 serving as a casing. The body case 101 houses components such as a heat exchanger 107, the compressor 64 (see FIG. 21), the expansion valve 74 (see FIG. 21), and an accumulator. The body case 101 has for instance a substantially cuboid shape. The body case 101 includes four side surfaces 104, and a top surface. Each side surface 104 is provided with an air inlet part 104a through which to take in air. The top surface is provided with an air outlet part 109 through which to blow out air. That is, with the outdoor unit according to Embodiment 5, air taken in from the side surface is blown out from the top surface.

A lower portion of the body case 101 is covered with an opening and closing panel 102A, a lower left side panel 102B, a lower back panel (not illustrated), and a lower right side panel (not illustrated). The lower portion of the body case 101 defines for instance a machine chamber 103 in which components such as the compressor 64 (see FIG. 21) are housed.

As illustrated in FIGS. 24 and 25, a heat exchange chamber 105, in which the heat exchanger 107 is housed, is provided higher than the machine chamber 103 of the body case 101. The heat exchanger 107 disposed near the air inlet of the axial fan 10 includes the following components: a plurality of fins with plate-like surfaces arranged side by side in parallel to each other; and heat transfer tubes penetrating the fins in a direction in which the fins are arranged side by side. The heat exchanger 107 acts as the condenser 72 (see FIG. 21) during cooling operation, and acts as the evaporator 73 (see FIG. 21) during heating operation. The heat exchanger 107 is connected to the compressor 64 (see FIG. 21) by use of a pipe or other components in between, and is further connected to unillustrated components such as the indoor-side heat exchanger and the expansion valve to form the refrigerant circuit 70 of the air-conditioning apparatus. Although the heat exchanger 107 is positioned to face each of the four side surfaces 104 of the body case 101, this is not intended to be limiting. That is, the heat exchanger 107 may be positioned to face at least one of the four side surfaces 104 of the body case 101.

As illustrated in FIGS. 24 and 25, a bell mouth 106 is provided higher than the heat exchange chamber 105 of the body case 101. The bell mouth 106 has a cylindrical shape, with the air outlet part 109 provided at the top of the bell mouth 106 to blow out air upward. As illustrated in FIG. 25, the axial fan 10 is housed in the bell mouth 106. A fan guard part 110 is attached to the bell mouth 106 to cover the top of the axial fan 10. The periphery portion of the fan guard part 110 is secured to the bell mouth 106.

As the axial fan 10 operates, air is taken in from the air inlet parts 104a illustrated in FIG. 24. As indicated by arrows 25 in FIG. 25, the air thus taken in is subjected to heat exchange when passing through the heat exchanger 107, and then the resulting air is exhausted from the air outlet part 109 illustrated in FIGS. 24 and 25.

Embodiment 5 provides advantageous effects similar to those of Embodiments 1 to 3 corresponding to Embodiment 5.

In the foregoing description of Embodiments 4 and 5, an outdoor unit has been described above as an example of an air-sending device. Further, as an example of the outdoor unit, an outdoor unit of an air-conditioning apparatus has been described above. However, such foregoing description is not intended to limit the scope of the present disclosure. In one alternative example, the air-sending device according to each of Embodiments 4 and 5 can be employed as an indoor unit of an air-conditioning apparatus. In another alternative example, the air-sending device can be also employed, for instance, as an outdoor unit or indoor unit of not an air-conditioning apparatus but another refrigeration cycle apparatus such as a water heater. In still another alternative example, the air-sending device according to each of Embodiments 4 and 5 can be employed for various apparatuses configured to send air, such as ventilating fans and ventilators. As described above, the air-sending device according to each of Embodiments 4 and 5 can be employed for, for example, an apparatus or equipment other than an outdoor unit. The axial fan 10 according to each of Embodiments 1 to 3 can be thus employed for air-sending devices in general, and refrigeration cycle apparatuses in general.

### REFERENCE SIGNS LIST

1: blade, 2: fan shaft, 3: shaft support, 3a: through-hole, 4: leading edge part, 4a: edge, 4aA: chain double-dashed line, 5: trailing edge part, 5a: edge, 5aA: chain double-dashed line, 6: outboard edge part, 6a: edge, 7: connection part, 7a: edge, 7aA: imaginary line, 8: stress distribution part, 8A: stress distribution part, 8a: edge, 8aa: edge, 9: arrow, 10: axial fan, 10R: axial fan, 11: rotational direction, 12: region, 12A: region, 12AA: region, 128: region, 20: arrow, 21: arrow, 22: arrow, 23: arrow, 24: arrow, 25: arrow, 30: cross-section, 31: cross-section, 32: cross-section, 51: outdoor unit body, 51a: side surface, 51b: front surface, 51c: side surface, 51d: back surface, 51e: top surface, 51f: bottom surface, 51g: partition plate, 52: front panel, 53: air outlet, 54: fan grille, 56: air-sending chamber, 57: machine chamber, 61: fan motor, 62: drive shaft, 63: bell mouth, 64: compressor, 65: pipe, 66: board case, 68: heat exchanger, 70: refrigerant circuit, 71: outboard end portion, 72: condenser, 72a: condenser fan, 73: evaporator, 73a: evaporator fan, 74: expansion valve, 81: opening, 82: constricted part, 83: bottom part, 84: arcuate part, 85: first inclined part, 85A: straight part, 86: second inclined part, 87: projection, 88: through-hole, 91: first region, 92: second region, 93: third region, 101: body case, 102A: opening and closing panel, 1028: lower left side panel, 103: machine chamber, 104: side surface, 104a: air inlet part, 105: heat exchange chamber, 106: bell mouth, 107: heat exchanger, 109: air outlet part, 110: fan guard part, Lb: diameter, Lint: inter-edge separation, S: axial direction, X: width direction, Y: depth direction, Z: height direction, r: radius, r0: radius, r1: radius, r2: radius

1. An axial fan comprising:
a plurality of blades configured to rotate around a central axis defined by a fan shaft; and
a connection part that is plate-like shaped, formed around the fan shaft, and connects, among the plurality of blades, blades that are adjacent to each other in a circumferential direction,
the connection part including a discontinuous part,
the discontinuous part forming a stress distribution part that distributes stress imposed on the connection part when the plurality of blades rotate,
the stress distribution part being defined by a cut, the cut extending radially in a shape of a recess from an outboard end portion of the connection part toward the fan shaft,
the stress distribution part including
an opening part defined in the outboard end portion of the connection part,
a bottom part positioned radially opposite to the opening part, and
a first region located between the opening part and the bottom part,
the blades that are adjacent to each other in the circumferential direction including a trailing blade and a leading blade, the stress distribution part having edges joined to an edge of a leading edge part of the trailing blade, and to an edge of a trailing edge part of the leading blade, the trailing blade being located rearward in a rotational direction of the blades, the leading blade being located forward in the rotational direction of the blades,
among the edges of the stress distribution part, two edges that lie on a circumference of a circle of same radius centered on the fan shaft and that are farthest from each other having a first inter-edge separation defined as a separation between the two edges,
the first region of the stress distribution part being a region where the first inter-edge separation decreases or remains constant in a radially outboard direction.

2. (canceled)

3. The axial fan of claim 1,
wherein the stress distribution part includes a second region located between the opening part and the first region, and
wherein the second region of the stress distribution part is a region where the first inter-edge separation in the stress distribution part increases in the radially outboard direction.

4. The axial fan of claim 1,
wherein the stress distribution part includes a third region, the third region including the bottom part and located further inboard than the first region, and
wherein the third region of the stress distribution part is a region where the first inter-edge separation in the stress distribution part increases in the radially outboard direction.

5. The axial fan of claim 4, wherein in front view perpendicular to the fan shaft, edges in the third region define an arcuate part in a form of a curve, the curve projecting inboard and having a single curvature or a plurality of curvatures.

6. The axial fan of claim 1,
wherein the stress distribution part includes a projection provided to the bottom part, and
wherein in front view perpendicular to the fan shaft, the projection projects outboard from the bottom part.

7. The axial fan of claim 6, wherein the projection has an edge defined as a curve with a single curvature or a plurality of curvatures.

8. The axial fan of claim 3,
wherein the stress distribution part includes a constricted part defining a boundary between the first region and the second region, and
wherein the first inter-edge separation in the constricted part is greater than or equal to 0 mm.

9. An air-sending device comprising:
the axial fan of claim 1;
a drive source configured to provide a drive force to the axial fan; and
a casing that houses the axial fan and the drive source.

10. A refrigeration cycle apparatus comprising:
the air-sending device of claim 9; and
a refrigerant circuit including a condenser and an evaporator,
wherein the air-sending device is configured to send air to at least one of the condenser and the evaporator.
